(19) United States
(12) Patent Application Publication
(10) Pub. No.: US 2016/0008795 A1
(43) Pub. Date: Jan. 14, 2016

(54) HYDROPROCESSING CATALYST FOR TREATING A HYDROCARBON FEED HAVING AN ARSENIC CONCENTRATION AND A METHOD OF MAKING AND USING SUCH CATALYST

(71) Applicant: SHELL OIL COMPANY, Houston, TX (US)

(72) Inventor: Josiane Marie-Rose GINESTRA, Richmond, TX (US)

(21) Appl. No.: 14/797,447

(22) Filed: Jul. 13, 2015

Related U.S. Application Data
(60) Provisional application No. 62/023,238, filed on Jul. 11, 2014.

(51) Int. Cl. B01J 27/19; B01J 35/00; C10G 45/08; B01J 37/00; B01J 37/02; B01J 37/08; B01J 21/04; B01J 35/02

(52) U.S. Cl. CPC B01J 27/19; B01J 21/04; B01J 35/0006; B01J 35/026; B01J 37/0072; B01J 37/024; B01J 37/088; C10G 45/08

(57) ABSTRACT

A catalyst that is useful for the removal of arsenic from hydrocarbon feedstocks. The catalyst comprises an alumina support, underbedded molybdenum and phosphorus components, and an overlayer of a nickel component. The catalyst further has the unique property of having a surface nickel-to-molybdenum atomic ratio of greater than 1.8 with a bulk nickel-to-molybdenum atomic ratio of less than 2.2. The nickel accessibility factor of the catalyst is greater than 1.2. The catalyst is prepared by the application of two metals impregnation steps with associated calcination steps that in combination provide for the underbedded metals and overlayer of nickel.

The present non-provisional application claims the benefit of U.S. Provisional Application No. 62/023,238, filed Jul. 11, 2014.

This invention relates to a catalyst and process that provide for the removal of arsenic from hydrocarbon feedstock and a method of making the catalyst.

Some hydrocarbon feedstocks, such as naphtha, crude distillates, and bitumen-derived feedstocks, that are to undergo hydrotreating to remove concentrations of organic sulfur and nitrogen compounds also have concentrations of arsenic. Arsenic is a poison to hydrotreating catalysts used in the hydrotreating of the hydrocarbon feedstocks. Even small concentrations of arsenic can poison a hydrotreating catalyst by irreversibly binding with the active nickel and deactivating it. The arsenic may be present in a hydrocarbon feedstock in the form of organoarsenic compounds and at concentrations ranging upwardly to 1 wppm or higher.

One particularly good catalyst that has been developed for use in removing arsenic from petroleum feedstocks is disclosed in U.S. Pat. No. 6,919,018 (Bhan). This catalyst comprises a porous refractory support that is impregnated with a Group VIB metal (molybdenum or tungsten) and a Group VIII metal (nickel or cobalt) in amounts such that the atomic ratio of the Group VIII metal-to-Group VIB metal is between 1.5 to 2.5 and at least 8 wt. % Group VIB metal. The support of the catalyst is a mixture of the porous refractory material and either nickel or cobalt that is shaped, dried and calcined. There is no mention of the support containing molybdenum or phosphorus. The catalyst is prepared by applying several impregnations of metal followed by drying and calcining. The first impregnation is with a Group VIII metal (nickel or cobalt) thereby providing an underbedded Group VIII metal. There is no mention that the first impregnation includes molybdenum or phosphorus. The second impregnation is with a Group VIB metal and optionally an additional amount of a Group VIII metal.

U.S. Pat. No. 5,389,595 (Simpson et al.) discloses a hydroprocessing catalyst that is useful for simultaneous hydrodenitrogenation and hydrodesulfurization of gas oil. The catalyst comprises a calcined porous refractory support particle, an underbedded Group VIII metal (e.g., nickel or cobalt) and an overlayer of an additional catalytic promoter that is preferably a Group VIB metal (e.g., molybdenum or tungsten) but may also be a Group VIII metal. The catalyst typically contains greater than 4.0 weight percent of Group VIII metal (calculated as monoxide) and greater than 10 weight percent (calculated as the trioxide). The '595 patent does not indicate that its catalyst has any particular application in arsenic removal. There also is no indication that its calcined support particle includes a catalytic metal component or that the catalyst includes underbedded Group VIB metal or underbedded phosphorus.

There is an ongoing need to develop improved arsenic removal catalyst compositions having enhanced ability to absorb and remove arsenic from hydrocarbon feedstocks containing arsenic and to hold the absorbed arsenic.

Accordingly, provided is a catalyst composition for use in hydroprocessing a hydrocarbon feedstock having a concentration of arsenic compounds. The catalyst composition comprises: an alumina support; an underbedded molybdenum component; an underbedded phosphorus component; an overlaid nickel component. The catalyst composition further has a surface nickel metal-to-molybdenum metal atomic ratio of greater than 1.8 as determined by X-ray Photoelectron Spectroscopy.

The catalyst composition is made by providing a formed alumina support particle; impregnating the formed alumina support particle with a molybdenum component and a phosphorus component to provide a first impregnated particle; calcining the first impregnated particle to provide a first calcined particle; impregnating the first calcined particle with a nickel component to provide a second impregnated particle; and calcining the second impregnated particle to provide the catalyst composition. The catalyst composition has a surface nickel metal-to-molybdenum metal atomic ratio of greater than 1.8 as determined by X-ray Photoelectron Spectroscopy.

The catalyst composition is useful in applications involving the hydroprocessing of hydrocarbon feedstocks that have a concentration of at least one arsenic compound so as to provide a treated hydrocarbon feed having reduced a reduced concentration of arsenic.

This invention is directed to a catalyst and its use in the hydrotreating of and removal of arsenic from hydrocarbon feedstocks. The invention also is directed to a method of making the inventive catalyst.

It has been discovered that a nickel-containing catalyst composition having a higher concentration of nickel on its surfaces, as determined by x-ray photoelectron spectroscopy analysis, which method is described in greater detail elsewhere herein, as compared to the bulk or average concentration of nickel throughout the catalyst composition provides a hydrotreating catalyst having an unexpectedly high arsenic absorption capability while still having good if not enhanced hydrodesulfurization activity.

In order to obtain a catalyst composition having the desired higher concentration of nickel in its surface as compared to the bulk or average concentration of nickel in the catalyst composition and to obtain a catalyst composition having other important characteristics that provide for the enhanced arsenic absorption capability, the nickel-containing catalyst composition of the invention needs to be prepared by a specific method as described herein.

One of the important aspects of the specific method is the manner by which the metal components of the catalyst are incorporated into the composition so as to provide the appropriate metal components that are in an underbedded form and those that are in an overlayer form. One of these aspects, as more fully described elsewhere herein, is for its hydrogenation metal components to be incorporated into the composition in a specific order and in amounts so as to provide for the proper metal components and their amounts to be contained in the catalyst in an underbedded form and for the proper metal components and their amounts to be contained in the catalyst in an overlayer form. These features are in addition to the catalyst of the inventive catalyst having a high nickel concentration in its surface as compared to the bulk concentration of the nickel.

The inventive catalyst is particularly useful in the hydrotreating, i.e., hydrodesulfurization and hydrodenitrogenation, of hydrocarbon feedstocks that contain a concentration of one or more organoarsenic compounds in addition to containing a concentration of one or more organic sulfur compounds or one or more organic nitrogen compounds or a combination of such compounds. The organoarsenic compounds that may be contained in the hydrocarbon feedstock are chemical compounds that include at least one arsenic atom that is chemically bonded to at least one carbon atom.

Examples of organic arsenic compounds that may be contained in the hydrocarbon feedstock to be treated with the inventive catalyst include those represented by the formulas: RAsO(OH)₂ or R₂AsO(OH) or R₃As, wherein each individual R functional group may be an alkyl group, having from 1 to 20 carbon atoms, or a phenyl group that may also have substituents. Specific examples of organic arsenic compounds include phenylarsonic acid, methylalkylphenylarsine, and triphenylarsine.

The arsenic concentration in the hydrocarbon feedstock typically can be in the range of from 0.5 weight parts per billion (ppbw) upwardly to 1000 ppbw. Historically, typical arsenic concentration in the hydrocarbon feedstock has been in the range of from 0.5 ppbw to 250 ppmb, however, with the shift toward heavier crudes and bitumen derived crudes, concentrations in the range of from 250 ppbw to 1000 ppbw are now becoming more frequent. Such high arsenic concentrations cause severe challenges to the refiners. The inventive catalyst is particularly useful in the processing of hydrocarbon feedstocks having arsenic concentrations in the range of from 250 ppbw to 1000 ppbw, and more particularly useful in the range of 500 ppbw to 1000 ppbw.

The inventive catalyst is capable of removing large amounts of arsenic from hydrocarbon feedstocks containing arsenic and of storing the removed arsenic. Thus, when the inventive catalyst is used upstream of a hydrotreating step, it provides an effective protection of the hydrotreating catalyst from the poisoning effects of arsenic. The inventive catalyst typically is capable of removing more than 98 wt. % of the arsenic contained in a hydrocarbon feedstock having a concentration of arsenic and, more significantly, it is able to remove more than 99.5 wt. % and even more than 99.9 wt. % of the arsenic contained in the hydrocarbon feedstock. This arsenic absorption and storage property of the inventive catalyst provides for treating hydrocarbon feedstocks having a contaminating arsenic concentration so as to yield a treated product having a reduced arsenic concentration of less than 0.005 ppmw, or less than 1 ppbw, or even less than 0.5 ppbw.

The inventive catalyst comprises a support particle that comprises a refractory oxide material and is in a form such as an extrudate, a pill, a tablet, a ball, or any other suitable agglomerated mass form. A preferred catalyst includes the support particle upon which is at least an underbedded molybdenum component and an underbedded phosphorus component and further upon which is an overlayer of a nickel component. It is desirable for there to be no material quantity or an absence of a molybdenum component in the catalyst as an overlayer. In another embodiment of the inventive catalyst, in addition to having no material quantity or an absence of or substantial absence of a molybdenum component as an overlayer, it also has no material quantity or an absence or substantial of a phosphorus component as an overlayer.

The terms “underbedded” and “overlayer” are defined and illustrated in detail in U.S. Pat. No. 5,389,595, which patent is incorporated herein by reference, and these terms are used herein in the same or similar manner as they are used in U.S. Pat. No. 5,389,595. It is a feature of the inventive catalyst for it to contain a significant amount of overlaid nickel while having no material or significant amount of either overlaid molybdenum or overlaid phosphorus, or both. In certain embodiments of the invention, the catalyst has a material absence or an absence of overlaid molybdenum or overlaid phosphorus, or both.

The metal components of the catalyst are deposited upon the support particle that comprises a porous refractory oxide material, such as, alumina, silica, titania, zirconia, alumino-silicate or any combination thereof. The preferred porous refractory oxide is alumina. The alumina can be of various forms, such as, alpha alumina, beta alumina, gamma alumina, delta alumina, eta alumina, theta alumina, boehmite, or mixtures thereof. It is preferred for the alumina to be an amorphous alumina such as gamma alumina.

The porous refractory oxide generally has an average pore diameter in the range of from about 50 Angstroms to about 200 Angstroms, preferably, from 70 Angstroms to 175 Angstroms, and, most preferably, from 80 Angstroms to 150 Angstroms. The total pore volume of the porous refractory oxide, as measured by standard mercury porisimetry methods, is in the range of from about 0.2 cc/gram to about 2 cc/gram. Preferably, the pore volume is in the range of from 0.3 cc/gram to 1.5 cc/gram, and, most preferably, from 0.4 cc/gram to 1 cc/gram. The surface area of the porous refractory oxide, as measured by the B.E.T. method, generally exceeds about 100 m²/gram, and it is typically in the range of from about 100 to about 400 m²/gram.

The support particle also has a material absence or, preferably, an absence of a nickel component or a molybdenum component or a phosphorus component or any combination of these components. Thus, the support particle of the inventive catalyst is a particle that comprises primarily a refractory oxide support material, such as alumina, and a material absence of or an absence of nickel or molybdenum or phosphorus or a combination thereof. This support particle is calcined prior to the incorporation of any of the hydrogenation metals. As an alternative embodiment, the support particle may also be defined as consisting essentially of or consisting of a refractory oxide material in the form of a particle that has been calcined.

In the preparation of the support particle, once the particle is formed, it is dried and then calcined in the presence of an oxygen-containing fluid, such as air, at a temperature that is suitable for achieving a desired degree of calcination so as to provide the calcined support particle upon which is incorporated the underbedded and overlaid metal components. Generally, the calcination temperature is in the range of from 800° F. (427° C.) to 1800° F. (982° C.), preferably between 1000° F. (538° C.) and 1500° F. (816° C.), and most preferably between 1250° F. (677° C.) and 1450° F. (788° C.).

One or more of the metal components are incorporated onto the calcined support particle which is thereafter calcined followed by placement of an overlayer of nickel. The nickel is laid on top of the calcined support particle that already has incorporated therein the one or more metal components of molybdenum, phosphorus and nickel, and has thereafter been calcined. The underbedded metal components are formed by the overlaying of the nickel on top of the calcined support and metal components. The nickel is a metal overlayer due to no further metals being deposited on top of the nickel after its calcination.

Each of the catalyst calcination steps is done in the presence of an oxygen-containing fluid, such as air, at a temperature that is suitable for achieving a desired degree of calcination. Generally, the calcination temperature is in the range of from 400° F. (205° C.) to 1100° F. (593° C.), preferably between 700° F. (371° C.) and 1000° F. (538° C.), and most preferably between 850° F. (454° C.) and 950° F. (510° C.).

It is an essential feature of the inventive catalyst composition for the concentration of nickel that is in its surface to be greater than the average concentration of nickel throughout the composition. It is theorized that by having the nickel concentrated in the surface of the catalyst particle instead of it being evenly or uniformly distributed throughout the catalyst composition, the nickel is more accessible to the contaminating arsenic that is contained in the hydrocarbon feedstock being treated using the catalyst and that it provides for better nickel utilization for arsenic absorption. The presence of molybdenum in the catalyst particle is thought to also be an important property of the catalyst by providing for the activation of the nickel so as to improve the rate at which the arsenic is captured from the hydrocarbon feedstock.

Thus, it has been found that the catalyst composition of the invention should have a surface nickel metal-to-molybdenum metal molar or atomic ratio (i.e., moles of elemental nickel/moles of elemental molybdenum) greater than 1.8. This surface Ni/Mo ratio is measured or determined by X-ray photoelectron spectroscopy, which provides a measurement of the concentration of nickel atoms and the concentration of molybdenum atoms contained in the outer 1 to 12 nm of the surface of the catalyst sample.

The method for determining the metal atoms in the surface of the catalyst composition should be in accordance with the following method or any other method that provides a substantially similar result or a result that can be correlated to provide a substantially similar result. The X-ray photoelectron spectroscopy analyses can be performed using a ThermoFisher Scientific K-Alpha X-ray photoelectron spectrometer or any other suitable X-ray photoelectron spectrometer equipment that is capable of providing a similar result. To conduct the measurement, a catalyst composition sample is lightly crushed with a mortar and pestle and mounted onto a sample stub using double-sided tape. Monochromatized Al kα (1484.6 eV) X-rays are used as the excitation source at a power of 72 mW. The X-ray spot size is approximately 400 microns. The electron kinetic energy analyzer is a 180 degree hemispherical analyzer equipped with a 128 channeltron detector or equivalent equipment. All spectra is obtained in the constant analyzer pass energy mode and the pass energy is set at 250 eV. Data is collected with a 0.25 eV step size. The Al2s peak is used for charge correction and is corrected to 118.9 eV. Linear baselines are used for measuring the peak areas of the Al2s, Mo3d and Ni2p peaks. Peak areas are converted to relative molar values using the following empirically derived sensitivity factors: Al2s-0.22, Mo3d-3.49, Ni2p-1.95 and the following relationship:

$$Relative number of atoms = \frac{( peak intensity / sensitivity factor ) * 100}{( A 12 s intensity / 0.22 )}$$

The numbers are reported as the number of atoms detected relative to 100 aluminum atoms.

The surface Ni/Mo ratio of the inventive catalyst is generally greater than 1.8. But, the larger the surface Ni/Mo ratio of the inventive catalyst, the better the catalyst is in absorbing arsenic. So, it is desirable for the surface Ni/Mo ratio of the inventive catalyst to be greater than 2. Preferably, the surface Ni/Mo can be greater than 2.2, and, most preferably, the surface Ni/Mo ratio is greater than 2.4.

While it is not really known if there is an upper limit for the surface Ni/Mo ratio in the inventive catalyst at which no or little incremental benefit for the absorption of arsenic is provided, it is thought that such an upper limit might be a surface Ni/Mo ratio of less than 10. Due to the difficulty of preparing a catalyst with a such high surface Ni/Mo ratio, a practical upper limit may be less than 8 or even less than 6.

The average or bulk nickel metal-to-molybdenum metal molar or atomic ratio of the catalyst composition of the invention may be less than 2.2. The bulk Ni/Mo ratio is defined as the total amount of elemental nickel in moles that is contained in the catalyst composition divided by the total amount of elemental molybdenum in moles that is contained in the catalyst composition. It is preferred for the bulk Ni/Mo ratio of the catalyst composition to be less than 2, and, more preferred, it is less than 1.9.

A more significant property of the inventive catalyst than either the surface Ni/Mo ratio or the bulk Ni/Mo ratio is the nickel accessibility factor of the catalyst. The nickel accessibility factor of the catalyst particle is defined as its surface Ni/Mo ratio divided by its bulk Ni/Mo ratio.

The nickel accessibility factor is an indicator of the relative concentration of the nickel in the surface of the catalyst composition as compared to the overall concentration of the nickel throughout the catalyst composition. A value of 1 for the nickel accessibility factor suggests that the nickel concentration is uniform within the catalyst composition. But, a value greater than 1 suggests that the concentration of the nickel is not uniform within the composition and is higher in the surface of the particle than throughout the composition as a whole. The greater this value is above 1, the higher the nickel concentration is in the surface of the catalyst composition relative to the bulk concentration of nickel.

In order for the inventive catalyst to exhibit the desired arsenic absorption properties, it is an essential property of the inventive catalyst to have a nickel accessibility factor that is greater than 1.2. It is more desirable for the catalyst to have a nickel accessibility factor that is greater than 1.25. It is preferred, however, for its nickel accessibility factor to exceed 1.3, and, most preferred, the nickel accessibility factor exceeds 1.4. Most preferably, the catalyst has a nickel accessibility factor greater than 1.5.

The total amount of nickel metal in the catalyst composition can be in the range of from 7 to 20 weight percent (wt. %) elemental metal based on the total weight of the catalyst composition. Preferably, the concentration of nickel metal in the hydroprocessing catalyst composition is in the range of from 10 weight % to 18 weight %, and, most preferably, the concentration is in the range of from 12 weight % to 16 weight %.

The total amount of molybdenum metal in the catalyst composition can be in the range of from 3 to 25 weight percent elemental metal, based on the total weight of the catalyst composition. Preferably, the total amount of molybdenum metal in the catalyst composition is in the range of from 5 weight % to 20 weight %, and, most preferably, the concentration is in the range of from 8 weight % to 18 weight %. In preferred embodiments of the inventive catalyst, substantially or essentially all the molybdenum contained in the catalyst composition is in underbedded form, and there is a non-material amount or a substantial absence of or an absence of molybdenum in the catalyst composition that is in the form of overlaid molybdenum.

The phosphorus may be present in the catalyst composition in an amount in the range of from 0.1 wt % to 5 wt %, calculated as the element. It is preferred for the phosphorus content of the catalyst composition to be in the range of from 0.3 wt % to 4 wt %, and, most preferably, from 0.4 wt % to 3.5 wt %, calculated as the element. In preferred embodiments of the inventive catalyst, substantially or essentially all the phosphorus contained in the catalyst composition is in underbedded form, and there is a non-material amount or a substantial absence of or an absence of phosphorus in the catalyst composition that is in the form of overlaid phosphorus.

In the method for preparing the inventive catalyst, once the calcined, formed alumina support particle is provided, two impregnation steps with each followed by a calcination step are used to prepare the catalyst and to provide for the underbedded metals and overlayer of nickel.

In the first impregnation step, molybdenum and phosphorus are incorporated into the alumina support particle in amounts so as to provide a final catalyst composition, i.e., after the second impregnation step and second calcination step, having the desired molybdenum content and phosphorus content as described elsewhere herein. In some embodiments of the invention, it can be desirable to also incorporate nickel into the calcined alumina support particle along with the molybdenum and phosphorus components. If nickel is incorporated into the calcined alumina support particle, then the amount of nickel that is included should be adjusted in coordination with the amount of nickel included as an overlayer so as to provide the required surface Ni/Mo ratio, bulk Ni/Mo ratio, and accessibility factor for the catalyst as well as the total amount of nickel that is to be contained in the final catalyst composition.

The first impregnation may be accomplished by any method known in the art, but, typically it is done by pore volume impregnation or saturation with an impregnation solution comprising the metal components. The first impregnation solution used to incorporate the molybdenum and phosphorus, and, nickel, if desired, into the alumina support particle is prepared by mixing together and dissolving a molybdenum source, a phosphorus source, and, if nickel is used, a nickel source in water. The application of heat and the addition of an acidic compound may be used to assist the dissolution of the metal sources.

Molybdenum compounds that may suitably be used in the preparation of the impregnation solution include, but are not limited to, molybdenum trioxide and ammonium molybdate. If molybdenum trioxide is employed in the impregnating solution, it will typically be added with phosphoric acid and heated When a phosphorus compound is used in the impregnation solution, it is typically added as a salt compound of phosphorus or an oxyacid of phosphorus. Suitable oxyacids of phosphorus include but are not limited to phosphorus acid (H₃PO₃), phosphoric acid (H₃PO₄), hydrophosphorus acid (H₃PO₂).

Nickel compounds suitable for use in the preparation of the impregnation solution include, but are not limited to, nickel hydroxide, nickel nitrate, nickel acetate, nickel carbonate and nickel oxide. Nickel hydroxide and nickel nitrate are the preferred nickel compounds with nickel nitrate being the most preferred.

Once the formed alumina support particle is impregnated with the molybdenum and phosphorus, and, optionally, nickel, the resulting first impregnated particle is dried and calcined so as to provide a first calcined particle. The first impregnated particle is dried in air typically at a drying temperature in the range of from 75° C. to 250° C. followed by application of the first catalyst calcination step. The first catalyst calcination step is conducted under the calcination conditions described above.

The first calcined catalyst particle comprises an alumina support having incorporated therein a molybdenum component and a phosphorus component. It may also further comprise a nickel component. These metal components that are contained in the first calcined particle are made into underbedded metal components by the second impregnation step followed by application of a second catalyst calcination step.

The second impregnation may be accomplished by a method similar to the one used for the first impregnation. The second impregnation solution used to incorporate the nickel into the first calcined particle is prepared by mixing together a nickel source with water. It is an important feature of the inventive method of preparing the inventive catalyst composition that the second impregnation solution comprises nickel and a material absence or substantial absence or an absence of molybdenum and phosphorus. Or, alternatively, the second impregnation solution consists essentially of or consists of a source of nickel, a solvent such as water, and a dissolution aide, if required or desired. Possible suitable nickel compounds are listed above.

One reason the second impregnation solution contains nickel and excludes molybdenum and phosphorus is so that the final catalyst composition contains in its surface a higher concentration of nickel than in the bulk of the catalyst composition. The amount of nickel used in the second impregnation solution is selected so as to provide a final catalyst composition having the required total amount of the nickel component and the amount of overlaid nickel that are required to give a final catalyst composition having the required surface Ni/Mo ratio and bulk Ni/Mo ratio necessary to give the nickel accessibility factor needed for the catalyst composition to have the enhanced arsenic absorption properties described herein.

Once the first calcined catalyst particle is impregnated with the second impregnation solution to provide a second impregnated catalyst particle, it is dried in air typically at a drying temperature in the range of from 75° C. to 250° C. followed by application of the second calcination step to provide the catalyst composition. The second catalyst calcination step is conducted under the calcination conditions described above.

The catalyst composition made by the inventive method comprises an alumina support, underbedded molybdenum, underbedded phosphorus, and overlaid nickel. In another embodiment of the catalyst composition, it may further include underbedded nickel in addition to the overlaid nickel. In other embodiments, the catalyst composition has a material absence or a substantial absence or an absence of underbedded nickel. The proportions of these metal components are such as to provide an inventive catalyst composition having a surface Ni/Mo ratio and a bulk Ni/Mo ratio that are required for the catalyst composition to have the require nickel accessibility factor as described elsewhere herein.

The catalyst of the invention is particularly useful, and, indeed, has been developed for the treatment of hydrocarbon feedstocks having significant concentrations of arsenic as described above. The inventive catalyst exhibits particularly enhanced arsenic absorption properties over catalysts known in the art.

Hydrocarbon feedstocks that can be treated using the inventive catalyst include petroleum-derived oils, for example, atmospheric distillates, vacuum distillates, cracked distillates, raffinates, hydrotreated oils, deasphalted oils; bitumen-derived hydrocarbon feedstocks; and any other hydrocarbon that can be subject to hydrotreatment. These hydrocarbon feedstocks typically have concentrations of sulfur from sulfur-containing compounds or nitrogen from nitrogen-containing compounds, or both. They further can include concentrations of arsenic compounds of the types and in the amounts as described herein.

Examples of hydrocarbon feedstocks that can be treated using the inventive catalyst include such streams as naphtha, which typically contains hydrocarbons boiling in the range of from 100° C. (212° F.) to 160° C. (320° F.), kerosene, which typically contains hydrocarbons boiling in the range of from 150° C. (302° F.) to 230° C. (446° F.), light gas oil, which typically contains hydrocarbons boiling in the range of from 230° C. (446° F.) to 350° C. (662° F.), and heavy gas oils containing hydrocarbons boiling in the range of from 350° C. (662° F.) to 430° C. (806° F.).

The arsenic removal conditions to which the inventive catalyst is subjected are selected as are required taking into account such factors as the type of hydrocarbon feedstock that is treated and the amounts of sulfur, nitrogen and arsenic contaminants contained in the hydrocarbon feedstock.

Generally, the hydrocarbon feedstock is contacted with the catalyst composition in the presence of hydrogen under arsenic removal conditions such as a contacting temperature generally in the range of from about 150° C. (302° F.) to about 538° C. (1000° F.), preferably from 200° C. (392° F.) to 450° C. (842° F.) and most preferably from 250° C. (482° F.) to 425° C. (797° F.).

The arsenic removal reaction pressure is typically in the range of from 2298 kPa (300 psig) to 20,684 (3000 psig). The liquid hourly space velocity (LHSV) is in the range of from 0.01 hr⁻¹ to 10 hr⁻¹.

The following examples are presented to further illustrate the invention, but they are not to be construed as limiting the scope of the invention.

### EXAMPLE 1

### Catalyst Preparation

This Example describes the preparation of certain catalysts of the invention and a comparison catalyst that were used in the tests of Example 2.

### Catalyst A (Inventive Catalyst)

A first metal (Ni/Mo/P) solution was prepared by heating a mixture of 50.29 g of nickel nitrate, 67.87 g of molybdenum oxide, 24.09 g of phosphoric acid solution and 80 g of water until the metals were completely dissolved. The solution was then cooled, its volume was adjusted to 170 cm³ with additional water, and the adjusted solution was used to impregnate 200 g of alumina extrudate having a pore volume of 0.87 cm²/g. The impregnated extrudate was dried at 350° F. for 4 hours followed by calcination at 900° F. for an hour to provide a calcined impregnated extrudate.

A second solution, containing nickel as the only metal component, (nickel-only solution) was then prepared with 83.74 g of nickel nitrate and enough water to obtain the nickel-only solution volume of 144 cm³. The calcined impregnated extrudate was then impregnated with the second solution followed by drying at 350° F. for 4 hours and calcination at 900° F. for one hour to provide the final catalyst composition.

The final catalyst composition contained 13.1% Mo, 13.1% Ni, and 1.9% P, with the weight percents assuming the metals are in the elemental form and based on the total weight of the catalyst. The bulk molar ratio of nickel-to-molybdenum of the catalyst was 1.63 moles elemental Ni/moles elemental Mo and its surface nickel-to-molybdenum molar ratio was 2.7. The nickel accessibility factor (i.e., the ratio of surface Ni/Mo to bulk Ni/M) of the catalyst was 1.65.

### Catalyst B (Inventive Catalyst)

A commercially regenerated Ni/Mo/P catalyst was impregnated with a nickel nitrate solution that contained no other hydrogenation metal. The amount of nickel impregnated into the regenerated catalyst was such as to add 10% Ni by weight to the regenerated catalyst. The impregnated regenerated catalyst was thereafter calcined at 900° F. for an hour so as to provide a final catalyst composition.

The final catalyst composition contained 11.9% Mo, 13.4% Ni, and 1.9% P, with the weight percents assuming the metals are in the elemental form and based on the total weight of the catalyst. The bulk molar ratio of Ni/Mo ratio was 1.84 moles of Ni/moles of Mo and the surface Ni/Mo molar ratio was 2.95. The nickel accessibility factor of this catalyst was 1.60.

### Catalyst C (Comparative Catalyst)

A nickel solution was prepared with 112 g of nickel nitrate flakes and enough water to bring the solution volume to 170 cm³. This nickel-only solution was used to impregnate 200 g of alumina extrudate having a pore volume of 0.87 cm²/g. The impregnated alumina extrudate was dried at 350° F. for 4 hours and calcined at 900° F. for an hour to provide a calcined impregnated extrudate containing nickel as the only hydrogenation metal.

A second (Ni/Mo/P) solution was then prepared by heating a mixture of 59.07 g of nickel nitrate flakes, 64.25 g of molybdenum oxide, 22.72 g of phosphoric acid solution and 80 g of water until the metals were dissolved. The solution was then cooled, its volume was adjusted to 166 cm³ with additional water, and then it was used to impregnate the nickel containing intermediate (i.e., the calcined nickel-impregnated extrudate). The calcined nickel-impregnated extrudate was then dried at 350° F. for 4 hours followed by calcination at 900° F. for an hour to provide the final catalyst composition.

The final catalyst composition contained 13.0% Mo, 10.9% Ni, and 1.9% P. The bulk molar Ni/Mo ratio was 1.37 and the surface Ni/Mo molar ratio was 1.64. The nickel accessibility factor of this catalyst was 1.20.

### EXAMPLE 2

### Arsenic Capacity

This Example describes the testing of the catalysts described in Example 1 to determine their arsenic absorption capacity and presents the results of this testing.

### Basket Test 1

Segregated amounts of Catalyst A and Catalyst C were put into a first basket that was placed into a hydrotreating reactor used in the hydroprocessing of a gas oil feedstock containing a concentration of arsenic. After the catalysts had become spent, they were analyzed to determine the arsenic loading on each. An analysis of the spent Catalyst A and spent Catalyst C revealed an arsenic loading of Catalyst A of 9.31 g of arsenic per 100 g of fresh Catalyst A and an arsenic loading of Catalyst B of 5.91 g arsenic per 100 g of fresh Catalyst C. Catalyst A, thus, collected 57% more arsenic than Catalyst B, on a per catalyst weight basis.

While it might have been expected for Catalyst A to exhibit a higher arsenic absorption capacity than Catalyst C by an amount that is proportional to the percentage difference in the nickel content of the two catalysts, it was not expected that the arsenic absorption capacity of Catalyst A would be significantly greater than 20% of the arsenic absorption capacity of Catalyst C. This is because Catalyst A only contained 20% more nickel than did Catalyst C. However, the performance advantage of Catalyst A over that of Catalyst C was unexpectedly significantly greater than 20%. It is believed that this is due to the increased nickel accessibility of Catalyst A over that of Catalyst C. The nickel accessibility factor of Catalyst A is 38% higher than the nickel accessibility factor of Catalyst C.

### Basket Test 2

Segregated amounts of Catalysts B and Catalyst C were put into a second basket that was placed into a hydrotreating reactor operated during a different process cycle from the one of Basket Test 1. After the catalysts had become spent, they were analyzed to determine the concentration of arsenic on each of the catalysts. An analysis of the spent Catalyst B and spent Catalyst C revealed that the arsenic loading was 9.13 g As per 100 g of fresh Catalyst B and 5.01 g As per 100 g of fresh Catalyst C. Catalyst B thus collected 82% more arsenic than Catalyst C, on a per catalyst weight basis. The inventive Catalyst B exhibited an unexpectedly higher arsenic absorption capacity than that exhibited by Catalyst C.

1. A catalyst composition for hydroprocessing a hydrocarbon feedstock having a concentration of arsenic compounds, wherein said catalyst composition comprises:
an alumina support;
an underbedded molybdenum component;
an underbedded phosphorus component;
an overlaid nickel component;
wherein said catalyst composition has a surface nickel metal-to-molybdenum metal atomic ratio of greater than 1.8 as determined by X-ray Photoelectron Spectroscopy.

2. A catalyst composition as recited in claim 1, wherein said catalyst composition has a nickel accessibility factor (i.e., surface Ni/Mo ratio-to-bulk Ni/Mo ratio) greater than 1.2.

3. A catalyst composition as recited in claim 1, wherein said catalyst composition has a bulk nickel metal-to-molybdenum metal atomic ratio of less than 2.2.

4. A catalyst composition as recited in claim 3, wherein said catalyst composition comprises: nickel in an amount in the range of from 7 wt. % to 20 wt. %, calculated as elemental nickel and based on the total weight of said catalyst composition; and molybdenum in an amount in the range of from 3 wt. % to 20 wt. %, calculated as elemental molybdenum and based on the total weight of said catalyst composition; and phosphorus in an amount in the range of from 0.1 wt. % to 5 wt. %, calculated as elemental phosphorus and based on the total weight of said catalyst composition.

5. A catalyst composition as recited in claim 4, wherein said alumina support comprises a formed particle consisting essentially of alumina.

6. A catalyst composition as recited in claim 5, wherein said catalyst composition comprises a material absence of underbedded nickel.

7. A catalyst composition as recited in claim 6, wherein said catalyst composition comprises a material absence of overlaid molybdenum and a material absence of overlaid phosphorus.

8. A method of making a catalyst composition, wherein said method comprises:
(a) providing a formed alumina support particle;
(b) impregnating said formed alumina support particle with a molybdenum component and a phosphorus component to provide a first impregnated particle;
(c) calcining said first impregnated particle to provide a first calcined particle;
(d) impregnating said first calcined particle with a nickel component to provide a second impregnated particle; and
(e) calcining said second impregnated particle to provide said catalyst composition;
wherein, said catalyst composition has a surface nickel metal-to-molybdenum metal atomic ratio of greater than 1.8 as determined by X-ray Photoelectron Spectroscopy.

9. A method as recited in claim 8, wherein said catalyst composition has a nickel accessibility factor (i.e., surface Ni/Mo ratio-to-bulk Ni/Mo ratio) greater than 1.2.

10. A method recited in claim 9, wherein said catalyst composition has a bulk nickel metal-to-molybdenum metal atomic ratio of less than 2.2

11. A method as recited in claim 10, wherein said amount of nickel incorporated into said catalyst composition is such as to provide a nickel content in said catalyst composition in the range of from 7 wt. % to 20 wt. %, calculated as elemental nickel and based on the total weight of said catalyst composition; and said amount of molybdenum incorporated into said catalyst composition is such as to provide a molybdenum content in said catalyst composition in the range of from 3 wt. % to 20 wt. %, calculated as elemental molybdenum and based on the total weight of said catalyst composition; and an amount of phosphorus incorporated into said catalyst composition is such as to provide a phosphorus content in said catalyst composition in the range of from 0.1 wt. % to 5 wt. %, calculated as elemental phosphorus and based on the total weight of said catalyst composition.

12. A method as recited in claim 11, wherein said alumina support particle consists essentially of alumina.

13. A method as recited in claim 11, wherein said catalyst composition comprises a material absence of underbedded nickel.

14. A method as recited in claim 11, wherein said catalyst composition comprises a material absence of overlaid molybdenum and a material absence of overlaid phosphorus.

15. A catalyst composition prepared by the method of claim 8.

16. A process for the hydroprocessing of a hydrocarbon feed having a concentration of arsenic compounds, wherein said process comprises: contacting said hydrocarbon feed with any one of the catalyst compositions of claim 1 under suitable hydrotreating and arsenic removal reaction conditions to provide a treated hydrocarbon feed.
